(19) United States
(12) Patent Application Publication
(10) Pub. No.: US 2007/0210267 A1
(43) Pub. Date: Sep. 13, 2007

(54) Optical ranging sensor and warm water wash toilet seat

(75) Inventors: Kentaroh Ishii, Katsuragi-shi (JP); Isamu Ohkubo, Kitakatsuragi-gun (JP); Akifumi Yamaguchi, Kashiba-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/710,986

(22) Filed: Feb. 27, 2007

(30) Foreign Application Priority Data
Feb. 27, 2006 (JP) 2006-050103
Dec. 19, 2006 (JP) 2006-341598

(51) Int. Cl. G01N 21/86; G01V 8/00

(52) U.S. Cl. 250/559.36

(57) ABSTRACT

A light receiving device 12 that receives reflected light condensed by a light receiving condenser means 14 has two first and second electrodes 15, 16 provided on a light receiving surface at prescribed intervals along a baseline that connects a light emitting device 11 with the light receiving device and a resistive region 21 provided between the two electrodes. An electric charge generated at the incident position of light incident on the light receiving surface of the light receiving device 12 becomes a photo current and outputted from the first and second electrodes 15, 16 via the resistive region 21. The resistance value of the resistive region 21 of the light receiving device 12 is distributed so as to be roughly inversely proportional to a distance from the optical axis of the light receiving condenser means 14 to the incident position of a light spot on the light receiving surface.

### CROSS-REFERENCE TO RELATED APPLICATIONS

This nonprovisional application claims priority under 35 U.S.C. §119(a) on Patent Application No. 2006-050103 filed in Japan on Feb. 27, 2006 and on Patent Application No. 2006-341598 filed in Japan on Dec. 19, 2006, the entire contents of which are hereby incorporated by reference.

### BACKGROUND OF THE INVENTION

The present invention relates to optical ranging sensors and more particularly to an optical ranging sensor that detects a distance to an object to be ranged by projecting light onto the object and receiving reflected light and a warm water wash toilet seat that employs the sensor.

As shown in FIG. 14, among conventional optical ranging sensors that detect a distance to an object is a ranging sensor that projects light from a light emitter onto the object, receives diffuse reflected light as spot light by a light receiving device 102 and detects the distance to the object on the basis of the position of the spot light (refer to JP 2003-156328 A).

As shown in FIG. 14, the optical ranging sensor 100 has a light emitting device 101 for projecting light onto the object to be ranged, a light projecting condenser means 103 that condenses light to be projected, a light receiving condenser means 104 that condenses reflection light reflected on the object to be ranged, and a light receiving device 102 that receives the reflection light condensed by the light receiving condenser means 104.

The light emitting device 101 is a light source of a light emitting diode or the like, and a luminous flux emitted from the light emitting device 101 is focused by the light projecting condenser means 103 provided in an optical path ahead of the emitting portion and projected onto the object to be ranged.

The light receiving device 102 is a PSD (Position Sensitive Device), and the reflection light that has been irregularly reflected on the object to be ranged is focused by the light receiving condenser means 104 provided ahead of a light receiving surface 102a and guided to the light receiving surface 102a.

The PSD is constructed of three layers of a p− layer of high resistivity provided on the surface of a flat plate silicon, an n+ layer provided on the back surface and an i (intrinsic) layer provided intermediate between the layers. When a light spot is applied to the surface of the PSD, the generated electric charges (carriers) are divided in the resistive layer (p− layer) in reverse proportion to a distance from the incident position of light to output electrodes 115, 116 and taken out as a current from each of the output electrodes 115, 116.

In the PSD, the resistive region (p− layer) located between the output electrodes 115, 116 has a zigzag pattern as indicated by reference numeral 120 in FIG. 16 so that the resistivity of the surface resistive layer (p− layer) comes to have a uniform distribution as shown in FIG. 15.

In the optical ranging sensor 100 of the above construction, light emitted from the light emitting device 101 passes through the light projecting condenser means 103 and projected onto the object to be ranged, and part of the light that has been diffuse reflected on the object to be ranged is incident on the light receiving surface 102a as a light spot focused by passing through the light receiving condenser means 104. The position where the light is incident on the light receiving surface 102a changes depending on the distance between the object to be ranged and the optical ranging sensor 100. When the incident position of the light spot on the light receiving surface 102a of the light receiving device 102 changes from a reference position, signal currents I1, I2 taken out of both ends of the light receiving device 102 change in accordance with the quantity of change. The signal currents outputted from the light receiving device 102 are converted, by a signal processing circuit of a control unit (not shown), into output signals S1, S2 expressed by the following equations.

S1=I1/(I1+I2)

S2=(I1−I2)/(I1+I2)

In the equations, I1 and I2 are expressed as:

I1=(d+2x)·I0/2d

I2=(d−2x)·I0/2d

wherein d represents a range in which the light spot travels on the light receiving surface of the PSD (102),

I0 represents a total photo current (I1+I2), and

x represents a distance from a center of the PSD (102) to the incident position of the light spot.

According to the following equation, which serves as a principle of trigonometrical ranging,

x=(A·f)/D

wherein A is a distance (base length) between an optical axis of the light projecting condenser means 103 and an optical axis of the light receiving condenser means 104,

f is a focal length of the light receiving condenser means 104, and

D is a distance from the center of a range L in which ranging can be carried out to the position of the object to be ranged.

The output signals S1, S2 are also expressed as follows.

$$\begin{matrix}S 1 = ( 2 x + d ) / 2 d \\ = [ \{ ( A \cdot f / D ) - B \} / d ] + 1 / 2 \\ S 2 = 2 x / d \\ = 2 \{ ( A \cdot f / D ) - B \} / d .\end{matrix}$$

wherein B represents a distance from the optical axis of the light receiving condenser means 104 to the center of the PSD (102). Assuming that X is a distance from the optical axis of the light receiving condenser means 104 to the incident position of the light spot on the PSD (102), there exists a relation X=B+x.

FIG. 17 shows one example of a change in the output signal of the optical ranging sensor 100 corresponding to the distance to the object to be ranged. As shown in FIG. 17, the change in the output signal from the optical ranging sensor 100 is basically inversely proportional to the distance to the object to be ranged on the basis of the equations of the output signal S1 or the output signal S2. That is, the change in the position of the light spot on the light receiving surface 102a of the light receiving device 102 is basically reduced as the distance to the object to be ranged is increased, and therefore, the change in the output is reduced concomitantly. On the other hand, the light spot goes out of the light receiving surface when the distance to the object to be ranged is a short distance, and therefore, the quantity of light to be received is rapidly reduced, and the output of the sensor is rapidly reduced concomitantly. In general, the region in which the light spot of the reflected light is on the light receiving surface, i.e., the region in which the output signal is inversely proportional to the distance to the object to be ranged is used as a ranging zone in the optical ranging sensor.

The conventional optical ranging sensor 100 has had a problem that, since the output signals are inversely proportional to the distance to the object to be ranged, the quantities of changes of the output signals S1, S2 became reduced as the distance to the object to be ranged is increased, and the ranging accuracy is reduced. Therefore, it has been unable to utilize the entire ranging zone that can be detected by the optical ranging sensor, and the ranging zone has needed to be limited in uses such that a ranging accuracy is needed at a long distance.

Accordingly, JP 2003-156328 A proposes an optical ranging sensor 200 that has two rangeable distances by means of two light emitting devices and one light receiving device as shown in FIG. 18. In FIG. 18 are shown light emitting devices 211, 212, a light receiving device 213, a light receiving surface 213a, a light projecting condenser means 214, a light projecting condenser means 215 and a light receiving condenser means 216. In the optical ranging sensor 200, assuming that a rangeable distance on the proximal side is L1, a rangeable distance on the distal side is L2, a base length of the light receiving device 213 and the light emitting device 212 is A1, and a base length of the light receiving device 213 and the light emitting device 211 is A2, then, according to the equations:

L1=(A1·f)/x

L2=(A2·f)/x,

there is obtained the equation:

L1:L2=A1/x:A2/x

According to the equation, the distance to the object to be ranged is detected in the ranging zones on both the proximal side and the distal side.

However, the optical ranging sensor 200 has a problem that it needs the two light emitting devices 211, 212 and the light projecting condenser means 214, 215 and this leads to a complicated structure of increased dimensions in comparison with the conventional optical ranging sensor 100. Moreover, the optical ranging sensor 200 has a problem that the ranging accuracy in the ranging zone intermediate between the proximal side and the distal side is lowered.

Moreover, JP H05-5619 A proposes a device in which the distribution of the resistance value of the resistive region (p− layer) of the PSD is proportional to a distance from one end of the PSD, as shown in FIG. 19. For example, an output signal proportional to the second power of the distance to the object to be ranged can be obtained by the method of making the resistive region (p− layer) of the light receiving surface of the PSD as indicated by reference numeral 220 in FIG. 20, logarithmically converting the currents I1 and I2 outputted from electrodes 215, 216 and taking a difference between the currents, and the dynamic range of the ranging can be widened.

However, the PSD has a problem that the ranging accuracy is not constant on the proximal side and the distal side.

### SUMMARY OF THE INVENTION

An object of the present invention is to provide an optical ranging sensor capable of accurately obtaining an output signal proportional to a distance to an object to be ranged in a wide ranging zone with a simple construction without changing the dimensions of the conventional optical ranging sensor and uniforming the ranging accuracy in the entire wide ranging zone and a warm water wash toilet seat that employs the sensor.

In order to achieve the above object, there is provided an optical ranging sensor of an optical trigonometrical ranging system comprising:

a light emitting device for emitting light;

a light projecting condenser means for condensing the light emitted from the light emitting device and projecting the light onto an object to be ranged;

a light receiving condenser means for condensing reflected light from the object to be ranged; and

a light receiving device, which is arranged so that the light receiving surface thereof is perpendicular to an optical axis of the light emitted from the light emitting device and receives the reflected light condensed by the light receiving condenser means, wherein

the light receiving device has two electrodes provided at prescribed intervals on the light receiving surface along a baseline that connects the light emitting device with the light receiving device and a resistive region provided between the two electrodes,

an electric charge generated at an incident position of light on the light receiving surface of the light receiving device becomes a photo current and is outputted from the two electrodes via the resistive region, and

a resistance value of the resistive region of the light receiving device is distributed so as to be roughly inversely proportional to a distance from an optical axis of the light receiving condenser means to an incident position of a light spot on the light receiving surface.

According to the optical ranging sensor having the above construction, the light emitted from the light emitting device is projected through the light projecting condenser means onto the object to be ranged and is diffuse reflected on the object to be ranged. Part of the reflected light is condensed by the light receiving condenser means and is incident on the light receiving surface of the light receiving device, forming a light spot. The position of the light spot on the light receiving surface of the light receiving device changes depending on the distance between the object to be ranged and the optical ranging sensor. The electric charge generated at the incident position of the light on the light receiving surface of the light receiving device becomes a photo current and is outputted from the two electrodes via the resistive region. As a result, a photo current proportional to the distance of the object to be ranged in the wide ranging zone is obtained. Therefore, an optical ranging sensor capable of accurately obtaining an output signal proportional to the distance of the object to be ranged in the wide ranging zone with a simple construction and uniforming the ranging accuracy in the entire wide ranging zone can be provided without changing the dimensions of the conventional optical ranging sensor.

In one embodiment of the invention, the resistive region has a zigzag bent line whose line width and return pitch interval are roughly identical, and the resistance value of the resistive region is distributed so as to be roughly inversely proportional to the distance from the optical axis of the light receiving condenser means to the incident position of the light spot on the light receiving surface by changing a stroke length of the bent line configuration from one electrode toward the other electrode of the two electrodes.

According to the optical ranging sensor of the above embodiment, by providing the resistive region of the light receiving device in the form of the zigzag bent line whose line width and return pitch interval are roughly identical with the stroke length of the bent line changed from one electrode toward the other electrode of the two electrodes, the resistive region in which the resistance value is roughly inversely proportional to the distance from the optical axis of the light receiving condenser means to the incident position of the light spot on the light receiving surface can easily be formed.

In one embodiment of the invention, the resistive region has a zigzag bent line whose stroke length and line width are roughly identical, and the resistance value of the resistive region is distributed so as to be roughly inversely proportional to the distance from the optical axis of the light receiving condenser means to the incident position of the light spot on the light receiving surface by changing a return pitch interval of the bent line configuration from one electrode toward the other electrode of the two electrodes.

According to the optical ranging sensor of the above embodiment, by providing the resistive region in the form of the zigzag bent line whose stroke length and line width are roughly identical with the return pitch interval of the bent line changed from one electrode toward the other electrode of the two electrodes, the resistive region in which the resistance value is roughly inversely proportional to the distance from the optical axis of the light receiving condenser means to the incident position of the light spot on the light receiving surface can easily be formed.

In one embodiment of the invention, the resistive region has a zigzag bent line whose stroke length and return pitch interval are roughly identical, and the resistance value of the resistive region is distributed so as to be roughly inversely proportional to the distance from the optical axis of the light receiving condenser means to the incident position of the light spot on the light receiving surface by changing a line width of the bent line configuration from one electrode toward the other electrode of the two electrodes.

According to the optical ranging sensor of the above embodiment, by providing the resistive region in the form of the zigzag bent line whose stroke length and return pitch interval are roughly identical with the line width of the bent line changed from one electrode toward the other electrode of the two electrodes, the resistive region in which the resistance value is roughly inversely proportional to the distance from the optical axis of the light receiving condenser means to the incident position of the light spot on the light receiving surface can easily be formed.

In one embodiment of the invention, the resistive region is a semiconductor layer having a zigzag bent line whose line width and return pitch interval are roughly identical, and the resistance value of the resistive region is distributed so as to be roughly inversely proportional to the distance from the optical axis of the light receiving condenser means to the incident position of the light spot on the light receiving surface by changing an impurity concentration of the semiconductor layer of the bent line configuration from one electrode toward the other electrode of the two electrodes.

According to the optical ranging sensor of the above embodiment, by providing the resistive region in the form of the zigzag bent line whose line width, stroke length and return pitch interval are roughly identical with the impurity concentration of the semiconductor layer of the bent line changed from one electrode toward the other electrode of the two electrodes, the resistive region in which the resistance value is roughly inversely proportional to the distance from the optical axis of the light receiving condenser means to the incident position of the light spot on the light receiving surface can easily be formed.

There is also provided an optical ranging sensor for detecting a distance to an object to be ranged by a trigonometrical ranging system comprising:

a light emitting device;

a light projecting condenser portion for condensing the light emitted from the light emitting device and projecting the light onto an object to be ranged;

a light receiving condenser portion for condensing reflected light from the object to be ranged;

a position detecting light receiving device, which is arranged so that a plane including the light receiving surface thereof is perpendicular to an optical axis of the light emitted from the light emitting device and receives the reflected light condensed by the light receiving condenser portion; and

an integrated circuit for carrying out processing of a signal outputted from the position detecting light receiving device and driving the light emitting device in accordance with a prescribed timing, wherein

the light receiving portion of the position detecting light receiving device is divided into a plurality of light receiving regions arranged along a baseline that connects the light emitting device with the position detecting light receiving device, and

the plurality of divided light receiving regions of the light receiving portion have mutually different resistance values.

According to the optical ranging sensor of the above construction, light emitted from the light emitting device passes through the light projecting condenser portion and is projected onto the object to be ranged and diffuse reflected on the object to be ranged. Part of the reflected light is condensed by the light receiving condenser portion and incident on the light receiving surface of the light emitting device, forming a light spot. The light condensing position of the light spot on the light receiving surface of the position detecting light receiving device changes depending on the distance from the object to be ranged to the optical ranging sensor. An electric charge generated at the incident position of the light on the light receiving surface of the position detecting light receiving device becomes a photo current and is outputted. By properly setting the resistance value every light receiving region in the light receiving portion of the position detecting light receiving device divided into a plurality of light receiving regions arranged along the baseline that connects the light emitting device with the position detecting light receiving device, a photo current proportional to the distance of the object to be ranged can be obtained in a wide ranging zone. Therefore, an optical ranging sensor capable of accurately obtaining an output proportional to the distance of the object to be ranged in the wide ranging zone with a simple construction and uniforming the ranging accuracy in the entire wide ranging zone can be provided. Although the absolute value of the output corresponding to the distance of the object to be ranged is varied depending on individual sensors, since the sensor can obtain an output proportional to the distance, if outputs at certain two positions are detected and externally stored, the distance can accurately be obtained by detecting the output of a third position and carrying out calculation outside the sensor by the data of the two points.

In one embodiment of the invention, a number of divisions of the light receiving portion of the position detecting light receiving device and the resistance values of the plurality of light receiving regions are set so that the output of the position detecting light receiving device is roughly proportional to the distance of the object to be ranged.

According to the embodiment, by setting the number of divisions of the light receiving portion of the position detecting light receiving device and the resistance values of the plurality of divided light receiving regions so that the output of the position detecting light receiving device is roughly proportional to the distance of the object to be ranged, the ranging accuracy can be further improved.

In one embodiment of the invention, the number of divisions of the light receiving portion of the position detecting light receiving device is five, areas of the plurality of divided light receiving regions are equalized, and ratios of the resistance values of the plurality of light receiving regions are 80:10:5:3:2 in order from the light emitting device side.

According to the above embodiment, by setting the number of divisions of the light receiving portion of the position detecting light receiving device to five, equalizing the areas of the divided light receiving regions and setting the ratios of the resistance values of the five light receiving regions at 80:10:5:3:2 in order from the light emitting device side, the linearity of the output voltage to the detection distance can be improved.

In one embodiment of the invention, the light receiving condenser portion is movable along a direction in which a light condensing position on the position detecting light receiving device moves in accordance with the distance to the object to be ranged, and

the light condensing position on the position detecting light receiving device can be changed by moving the light receiving condenser portion.

It can be considered that, even if the linearity of the output voltage representing the detection distance of the optical ranging sensor is improved, the linearity might be degraded when the positional relation between the light receiving condenser portion and the position detecting light receiving device is varied and the reflected light from the object located at a prescribed distance is not condensed to a prescribed position on the light receiving surface of the position detecting light receiving device. Therefore, according to the above embodiment, the light receiving condenser portion is made to have a movable structure, and the light condensing position on the position detecting light receiving device is changed, allowing the light spot to be formed at a prescribed position. This arrangement makes it possible to adjust the variation in the positional relation between the light receiving condenser portion and the position detecting light receiving device.

In one embodiment of the invention, a warm water wash toilet seat comprising the above optical ranging sensor.

According to the construction, by mounting the optical ranging sensor capable of uniforming the ranging accuracy in the entire wide ranging zone, a person can reliably be detected since the variation in the output with respect to the distance of the optical ranging sensor is small, and the function of the warm water wash toilet seat can normally be operated.

As is apparent from the above, according to the optical ranging sensor of the present invention, the ranging accuracy from a short distance to a long distance can be uniformed with a simple construction without changing the dimensions of the conventional optical ranging sensor.

According to another optical ranging sensor of the present invention, the distance to the object to be ranged existing in the prescribed distance range can be detected by accurately obtaining an output proportional to the distance, and therefore, even the distance of an object to be ranged existing in the long distance can accurately be detected.

Moreover, according to the warm water wash toilet seat of the present invention, the function of the warm water wash toilet seat can normally be operated by mounting the optical ranging sensor capable of uniforming the ranging accuracy in the entire wide ranging zone.

### BRIEF DESCRIPTION OF THE DRAWINGS

The present invention will become more fully understood from the detailed description given hereinbelow and the accompanying drawings which are given by way of illustration only, and thus are not intended to limit the present invention, and wherein:

FIG. 1 is a view showing the structure of an optical ranging sensor according to a first embodiment of the present invention;

FIG. 2 is a view showing the pattern configuration of the resistive region (p− layer) of a PSD used as a light receiving device of the optical ranging sensor;

FIG. 3 is a view showing the pattern configuration of the resistive region (p− layer) of a PSD used as a light receiving device of an optical ranging sensor according to a second embodiment of the present invention;

FIG. 4 is a view showing the pattern configuration of the resistive region (p− layer) of a PSD used as a light receiving device of an optical ranging sensor according to a third embodiment of the present invention;

FIG. 5 is a view showing the pattern configuration of the resistive region (p− layer) of a PSD used as a light receiving device of an optical ranging sensor according to a fourth embodiment of the present invention;

FIG. 6 is a view showing the pattern configuration of the resistive region (p− layer) of a PSD used as a light receiving device of an optical ranging sensor according to a fifth embodiment of the present invention;

FIG. 7 is a sectional view showing the structure of the PSD used for the optical ranging sensor of the first embodiment;

FIG. 8 is a graph showing the resistivity distribution of the resistive region of the PSD used for the optical ranging sensor of the first embodiment;

FIG. 9 is a graph showing a relation between the distance and the output signal of the optical ranging sensor of the present invention;

FIG. 10A is a front view of an optical ranging sensor according to one embodiment of the present invention;

FIG. 10B is a sectional view of the optical ranging sensor viewed from the line IB-IB of FIG. 10A;

FIG. 11A is a view showing the structure of the optical ranging sensor;

FIG. 11B is a plan view of the light receiving portion of a position detecting light receiving device used for the optical ranging sensor;

FIG. 12A is a graph for explaining the ratio of a total resistance at a distance from the left end of the light receiving surface of the position detecting light receiving device;

FIG. 12B is a graph showing the output characteristic of the position detecting light receiving device;

FIG. 13A is a front view and a sectional view showing a movable structure of a light receiving condenser portion of the optical ranging sensor;

FIG. 13B is a schematic view of a cross section viewed from the line IVB-IVB of FIG. 13A;

FIG. 14 is a view showing the structure of a conventional optical ranging sensor;

FIG. 15 is a graph showing the resistivity distribution of the resistive region of the conventional PSD;

FIG. 16 is a view showing the pattern configuration of the resistive region (p− layer) of the conventional PSD;

FIG. 17 is a graph showing a relation between the distance and the output signal of the conventional optical ranging sensor;

FIG. 18 is a view showing the structure of a conventional optical ranging sensor having a plurality of light emitting devices;

FIG. 19 is a graph showing the resistivity distribution of the resistive region of the conventional PSD; and

FIG. 20 is a view showing the pattern configuration of the resistive region (p− layer) of the conventional PSD.

### DETAILED DESCRIPTION OF THE INVENTION

Hereinbelow, the optical ranging sensor of the present invention will be described in detail with reference to embodiments shown in the drawings.

### First Embodiment

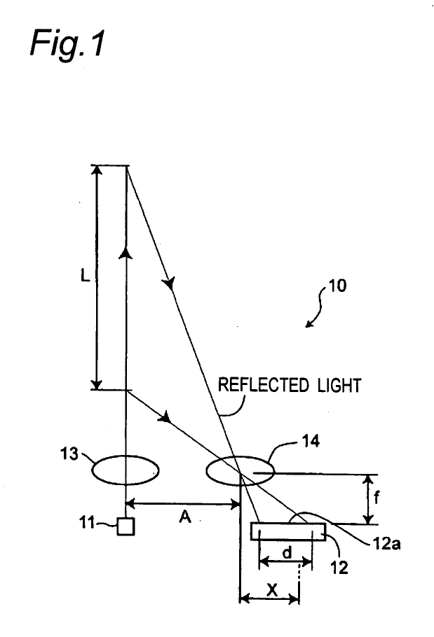

FIG. 1 is a schematic view showing the basic construction of an optical ranging sensor according to the first embodiment of the present invention.

As shown in FIG. 1, the optical ranging sensor 10 of the first embodiment includes a light emitting device 11 that emits light, a light projecting condenser means 13 that condenses light emitted from the light emitting device 11 and applies the light to an object to be ranged, a light receiving condenser means 14 that condenses the reflected light from the object to be ranged (not shown), and a light receiving device 12 that is arranged so that the light receiving surface becomes perpendicular to the optical axis of the light emitted from the light emitting device 11 and receives the reflected light condensed by the light receiving condenser means 14.

The light emitting device 11 is a light source of a light emitting diode or the like, and the light emitted from the light emitting device 11 is focused by the light projecting condenser means 13 provided in an optical path ahead of the emitting portion and projected onto the object to be ranged.

The light receiving device 12 is a PSD (Position Sensitive Device), and the reflected light that has been diffuse reflected on the object to be ranged is focused by the light receiving condenser means 14 provided ahead of a light receiving surface 12a and guided to the light receiving surface 12a.

The light emitted from the light emitting device 11 passes through the light projecting condenser means 13 and is projected onto the object to be ranged, and part of the light that has been diffuse reflected on the object to be ranged is incident on the light receiving surface 12a as a light spot focused by passing through the light receiving condenser means 14. The position of the incident light on the light receiving surface 12a changes depending on a distance between the object to be ranged and the optical ranging sensor 10. When the incident position of the light spot on the light receiving surface 12a changes from a reference position (center of the light receiving surface 12a), signal currents I1 and I2 taken out of both ends of the light receiving device 12 are changed in accordance with the quantity of change. Then, the signal currents outputted from the light receiving device 12 are converted into output signals by a signal processing circuit of a control unit (not shown).

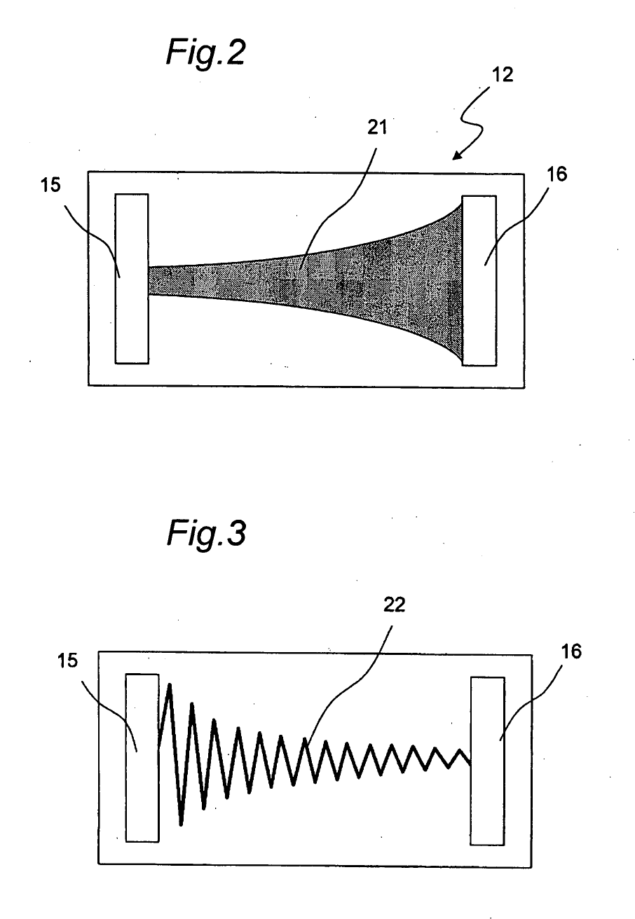

FIG. 2 shows the light receiving surface of the PSD used as the light receiving device 12 of the optical ranging sensor of the first embodiment.

As shown in FIG. 2, the PSD is a position sensor for detecting a light spot utilizing a silicon photodiode and obtains a continuous electrical signal.

As shown in the sectional view of FIG. 7, the PSD of the optical ranging sensor of the first embodiment is provided by diffusively growing an n+ layer 31 and an i layer 32 successively on a silicon substrate surface, thereafter forming a p− layer 33 of a prescribed pattern on the i layer 32 and forming a back electrode 30 on the back surface side of the n+ layer 31. Further, first and second electrodes 15, 16 are formed on the i layer 32 with interposition of a prescribed interval. The first and second electrodes 15, 16 are connected with each other via a p− layer 33.

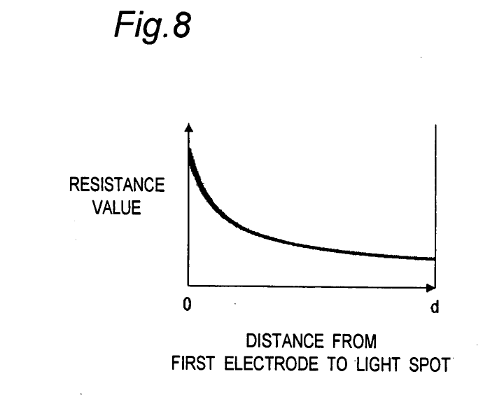

As shown in FIG. 2, a resistive region 21 constructed of the resistive layer (p− layer 33) between the first electrode 15 and the second electrode 16 is set so that the resistance value thereof is inversely proportional to a distance from the optical axis of the light receiving condenser means 14 to the incident position of the light spot on the light receiving surface 12a as shown in FIG. 8.

The resistive region 21 is formed by patterning through a photolithography step of a general semiconductor silicon process.

In the PSD of the optical ranging sensor of the above construction, when a light spot is incident on the light receiving surface 12a of the PSD, an electric charge proportional to the light energy is generated at the incident position of the light spot through photoelectric conversion. Then, the generated electric charge is outputted divided from the first and second electrodes 15, 16 as photo currents via the resistive layer (p− layer 33).

At this time, the resistance value of the surface resistive layer (p− layer 33) is set so as to be inversely proportional to the distance from the optical axis of the light receiving condenser means 14 between the first and second electrodes 15, 16. Therefore, a relation between the photo currents I1, I2 outputted from the first and second electrodes 15, 16 and a distance X (refer to FIG. 1) of the incident position of the light spot from the optical axis of light receiving condenser means 14 on the PSD (12) is calculated by the following equations.

It is assumed that the resistance value between the first and second electrodes 15, 16 is R. Since the resistance value is set so as to be inversely proportional to the distance of the incident position of the light spot from the optical axis of the light receiving condenser means 14 on the light receiving surface 12aassuming that the resistance value between the optical axis of the light receiving condenser means 14 and the incident position of the light spot on the light receiving surface 12a is R1 and the resistance value between the incident position of the light spot on the light receiving surface 12a and the second electrode 16 is R2, then there hold:

R1=α/X

R2=R−R1=R−α/X

wherein α is an arbitrary constant.

Since a voltage difference generated when the photo current I1 flows through the resistance R1 is equal to a voltage difference generated when the photo current I2 flows through the resistance R2, there hold:

I1·R1=I2·R2

I1·α/X=I2·(R−α/X)

If the above equations are rearranged by using the relation: I1+I2=I, there hold:

I1=(1−α/(R·X)·I

I2=α·I/(R·X)

The currents I1 and I2, which flow to the first and second electrodes 15, 16, have a relation of inverse proportion to the distance X.

The distance X from the optical axis of the light receiving condenser means 14 to the incident position of the light spot on the PSD (12) has a relation of inverse proportion to a distance L to the position of the object to be ranged according to the principle of trigonometrical ranging (similar figures) as expressed by the following equation:

X=(A·f)/L

wherein

A is a distance (base length) between the optical axis of the light projecting condenser means 13 and the optical axis of the light receiving condenser means 14,

f is the focal length of the light receiving condenser means 14, and

L is the distance to the position of the object to be ranged.

According to the above two equations, the photo current I has a relation of direct proportion to the distance L to the position of the object to be ranged as expressed by the following equation.

I∝L/(A·f)

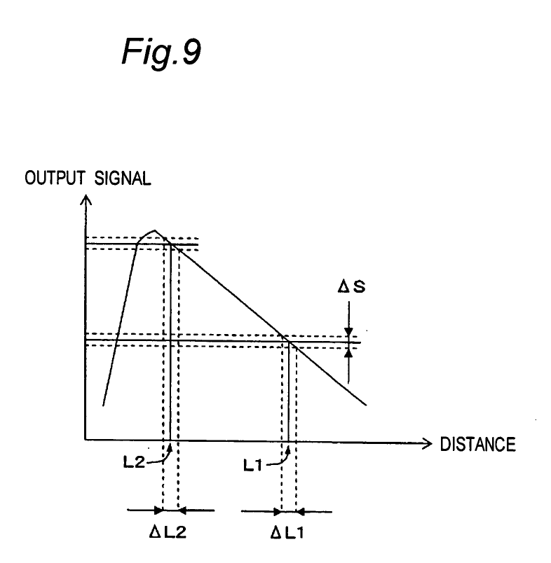

With the resistance value between the first and second electrodes 15, 16 formed so as to have the relation of inverse proportion to the distance X from the optical axis of the light receiving condenser means 14 as described above, the optical signal I outputted from the optical ranging sensor has a value proportional to the incident spot position of the PSD as shown in FIG. 9.

As described above, since the output that changes at a constant rate either at a short distance or a long distance to the position of the object to be ranged, an optical ranging sensor that has high accuracy in a wide distance range can be provided.

### Second Embodiment

FIG. 3 shows the light receiving surface of a PSD used as a light receiving device of an optical ranging sensor according to the second embodiment of the present invention. It is noted that the optical ranging sensor of the second embodiment has the same construction as that of the optical ranging sensor of the first embodiment except for the PSD, and reference should be made to FIG. 1 with no additional description provided therefor.

As shown in FIG. 3, in the PSD of the optical ranging sensor of the second embodiment, a resistive region 22 is formed of a p− layer in the form of a zigzag bent line. The resistive region 22 is designed so that the resistance value thereof between the first and second electrodes 15, 16 is inversely proportional to the distance from the optical axis of the light receiving condenser means 14 by making the line width and the return pitch interval of the bent line constant and changing the stroke length.

Because the resistance value of the resistive region 22 is decreased from the first electrode 15 toward the second electrode 16, the quantity of change in the output current can be increased with respect to the amount of shift of the light spot caused by the quantity of change of the object position to be ranged on the first electrode 15 side (the side on which the resistance value of the resistive region 22 is larger) of the light receiving surface of the PSD. Therefore, the ranging accuracy can be improved when the position of the object is located at a long distance.

### Third Embodiment

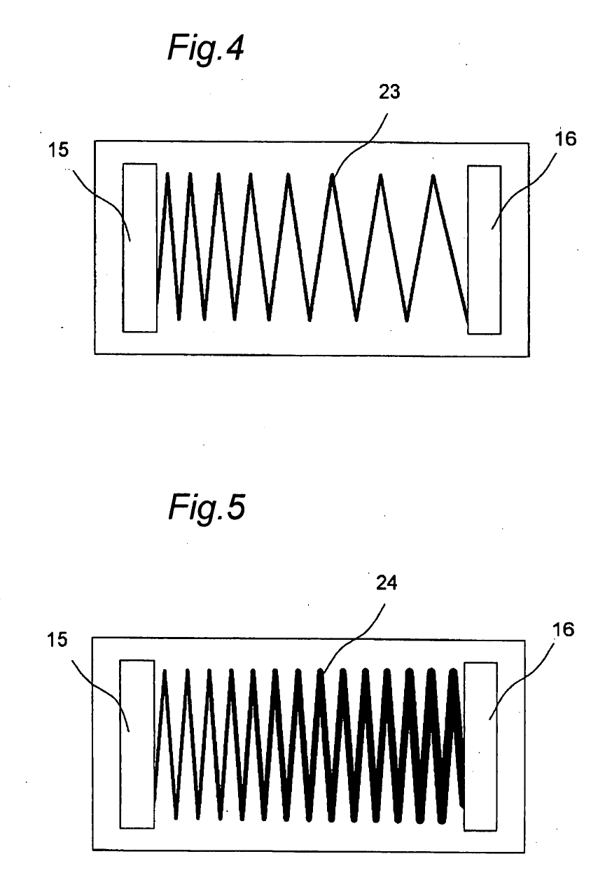

FIG. 4 shows the light receiving surface of a PSD used as a light receiving device of an optical ranging sensor according to the third embodiment of the present invention. The optical ranging sensor of the third embodiment has a construction identical to that of the optical ranging sensor of the first embodiment except for the PSD, and reference should be made to FIG. 1 with no additional description provided therefor.

As shown in FIG. 4, in the PSD of the optical ranging sensor of the third embodiment, a resistive region 23 is formed of a p− layer in the form of a zigzag bent line. The resistive region 23 is set so that the resistance value thereof between the first and second electrodes 15, 16 is inversely proportional to the distance from the optical axis of the light receiving condenser means 14 by making the line width and the stroke length of the bent line constant and changing the return pitch interval.

In the PSD of the optical ranging sensor, a light spot should desirably be incident on the neighborhood of the resistive region 23 in order to efficiently take out a photo current.

According to the optical ranging sensor of the second embodiment shown in FIG. 3, although the output accuracy is obtained by adjusting the optical lens used for the light receiving condenser means 14 and focusing the size of the light spot, the position of the light spot needs to be adjusted at the time of assembling.

In contrast to this, according to the optical ranging sensor of the third embodiment shown in FIG. 4, an optical ranging sensor, which is not required to reduce the size of the light spot, obviates the need for the adjustment at the time of assembling and has high accuracy can be provided more simply.

### Fourth Embodiment

FIG. 5 shows the light receiving surface of a PSD used as a light receiving device of an optical ranging sensor according to the fourth embodiment of the present invention. The optical ranging sensor of the fourth embodiment has a construction identical to that of the optical ranging sensor of the first embodiment except for the PSD, and reference should be made to FIG. 1 with no additional description provided therefor.

As shown in FIG. 5, in the PSD of the optical ranging sensor of the fourth embodiment, a resistive region 24 is formed of a p− layer in the form of a zigzag bent line. The resistive region 24 is set so that the resistance value thereof between the first and second electrodes 15, 16 is inversely proportional to the distance from the optical axis of the light receiving condenser means 14 by making the stroke length and the return pitch interval of the bent line constant and changing the line width.

In the PSD of the optical ranging sensor, a light spot should desirably be incident on the neighborhood of the resistive region in order to efficiently take out a photo current.

According to the optical ranging sensor of the third embodiment shown in FIG. 4, since the return pitch interval of the resistive region 23 formed in the bent line configuration is wider on the second electrode 16 side, the efficiency of taking out the photo current becomes nonuniform, and the ranging accuracy is lowered.

In contrast to the above, according to the optical ranging sensor of the fourth embodiment shown in FIG. 5, since the return pitch interval of the resistive region 24 is uniform, an optical ranging sensor capable of uniformly taking out a photo current between the first and second electrodes 15, 16 and having a uniform ranging accuracy can be provided.

### Fifth Embodiment

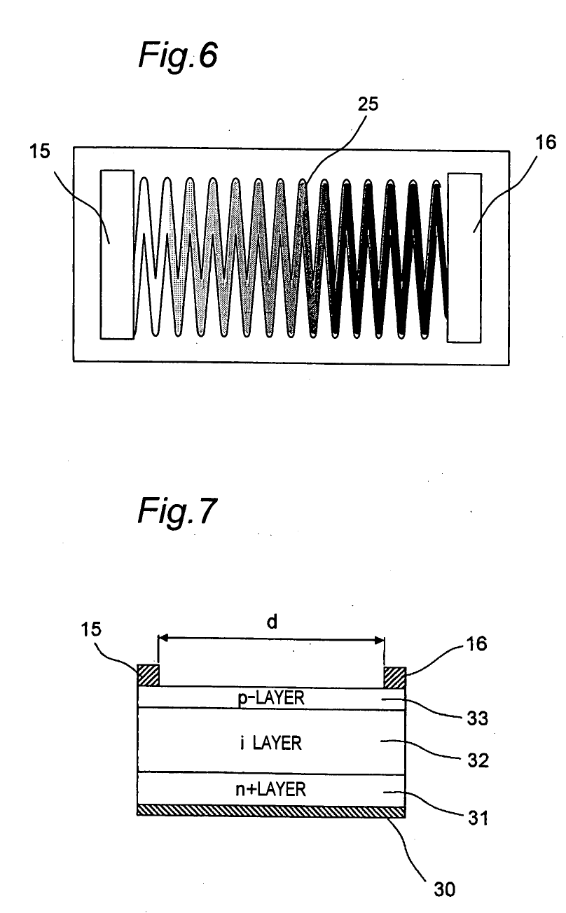

FIG. 6 shows the light receiving surface of a PSD used as a light receiving device of an optical ranging sensor according to the fifth embodiment of the present invention. The optical ranging sensor of the fifth embodiment has a construction identical to that of the optical ranging sensor of the first embodiment except for the PSD, and reference should be made to FIG. 1 with no additional description provided therefor.

As shown in FIG. 6, in the PSD of the optical ranging sensor of the fifth embodiment, a resistive region 25 is formed of a p− layer in the form of a zigzag bent line. The resistive region 25 is set so that the resistance value thereof between the first and second electrodes 15, 16 is inversely proportional to the distance from the optical axis of the light receiving condenser means 14 by making the stroke length, the return pitch interval and the line width of the bent line constant and changing the impurity concentration of the resistive region 24 (p− layer).

In the PSD of the optical ranging sensor, a light spot should desirably be incident on the neighborhood of the resistive region 25 in order to efficiently take out a photo current.

According to the optical ranging sensor of the fourth embodiment shown in FIG. 5, since the line width of the resistive region 24 formed in the bent line configuration is thicker on the second electrode 16 side, the efficiency of taking out the photo current becomes nonuniform, and the ranging accuracy is lowered.

In contrast to the above, according to the optical ranging sensor of the fifth embodiment shown in FIG. 6, since the line width of the resistive region 25 is constant, an optical ranging sensor capable of uniformly taking out a photo current between the first and second electrodes 15, 16 and having a uniform ranging accuracy can be provided.

Another optical ranging sensor and a warm water wash toilet seat of the present invention are described in detail next with reference to the embodiments shown in the drawings.

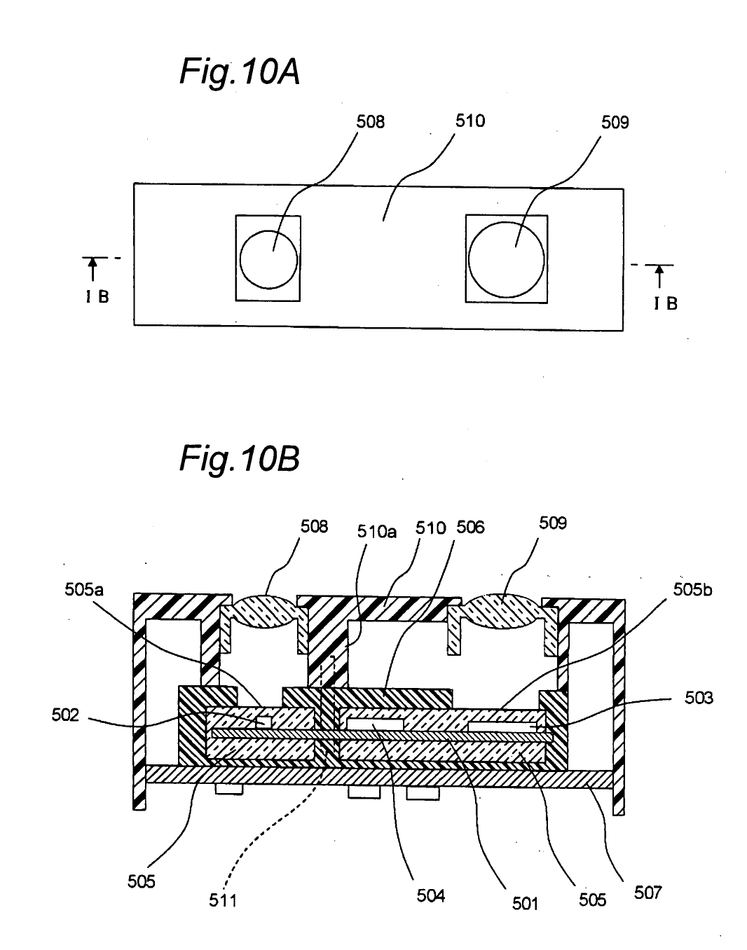

FIG. 10A shows a front view of an optical ranging sensor according to one embodiment of the present invention, and FIG. 10B shows a sectional view of the optical ranging sensor viewed from the line IB-IB of FIG. 10A.

As shown in FIGS. 10A and 10B, the optical ranging sensor includes one light emitting device 502 placed on a lead frame 501, one position detecting light receiving device 503, and one IC 504 that carries out processing of a signal outputted from the position detecting light receiving device 503 and drives the light emitting device 502 side in accordance with a prescribed timing. The light emitting device 502 and the position detecting light receiving device 503 are separately molded with a translucent resin 505, so that the packages (light emitting device 502 and position detecting light receiving device 503) are kept apart from each other at a definite interval by the lead frame 501.

In this case, the light emitting device 502 has an emission wavelength whose peak sensibility is in the infrared region, and the position detecting light receiving device 503 has a photodetection wavelength whose peak sensibility is in the infrared region. Moreover, the light receiving portion of the position detecting light receiving device 503 is divided into a plurality of light receiving regions 503a503b, 503c, 503d and 503e arranged along a baseline that connects the light emitting device 502 with the position detecting light receiving device 503, and the light receiving regions 503a-503e have mutually different resistance values. In the present embodiment, the number of divisions of the light receiving portion is five, the areas of the light receiving regions 503a-503e are equalized, and the ratios of the resistance values of the five light receiving regions 503a-503e are set at 80:10:5:3:2 in order from the light emitting device 502 side.

Next, the translucent resin mold is integrally molded with a light shielding resin 506 except for window portions 505a505b that become the optical passages of the light emitting device 502 and the position detecting light receiving device 503. After the integrally molded device is mounted on a board 507 and necessary electrical components (resistors, capacitors and so on) are mounted on the board 507, the board 507 is fixed to a casing 510 provided with a light projecting condenser portion 508 and a light receiving condenser portion 509 with a screw 511.

The casing 510 is made of a resin that has a light shielding property and electric conductivity in the portion excluding the light projecting condenser portion 508 and the light receiving condenser portion 509, and the light projecting condenser portion 508, the light receiving condenser portion 509 and the casing 510 are integrally molded by coinjection molding. Moreover, the light projecting condenser portion 508 and the light receiving condenser portion 509 are made of a material having an optical characteristic that cuts off the visible light, and even if visible light exists as external turbulence light, the light does not reach the light receiving regions 503a-503e of the position detecting light receiving device 503. Moreover, an inner wall 510a for shielding between the light projecting condenser portion 508 side and the light receiving condenser portion 509 side is provided for the casing 510 so that light from the light emitting device 2 is not directly incident on the light receiving regions 503a-503e. Furthermore, a conductive resin material is used for the casing 510 made of the resin having a light shielding property and is electrically connected to a ground terminal (ground portion of the lead frame) of the optical ranging sensor with a metallic screw, so that a stable output is obtained with the influence of external electromagnetic noises removed by a shielding effect.

The IC 504 that carries out processing of the signal outputted from the position detecting light receiving device 503 and drives the light emitting device 502 in accordance with a prescribed timing has the functions of making the light emitting device 502 emit pulse light by a prescribed frequency within a prescribed period, extracting the signal on the position detecting light receiving device 503 side as an effective signal in synchronization with the light emitting timing and outputting the signal as the mean value of the emitted light pulses. By this operation, even if steady external turbulence light is incident on the light receiving regions 503a-503e of the optical ranging sensor, the influence of the external turbulence light is canceled, and accurate detection can be achieved.

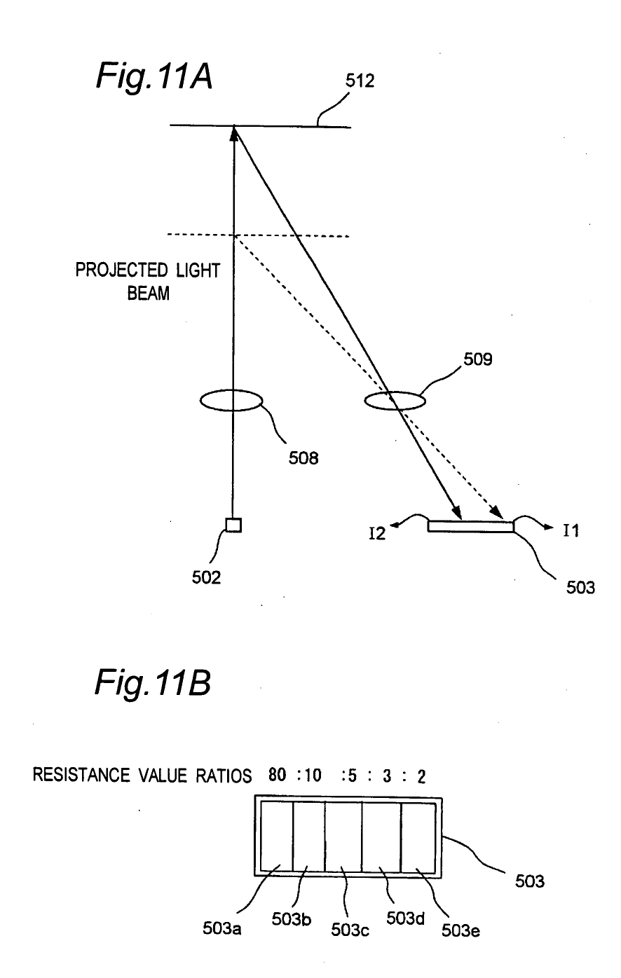

FIG. 11A shows the structure of the optical ranging sensor, and FIG. 11B shows a plan view of the light receiving regions 503a-503e of the position detecting light receiving device 503 employed in the optical ranging sensor.

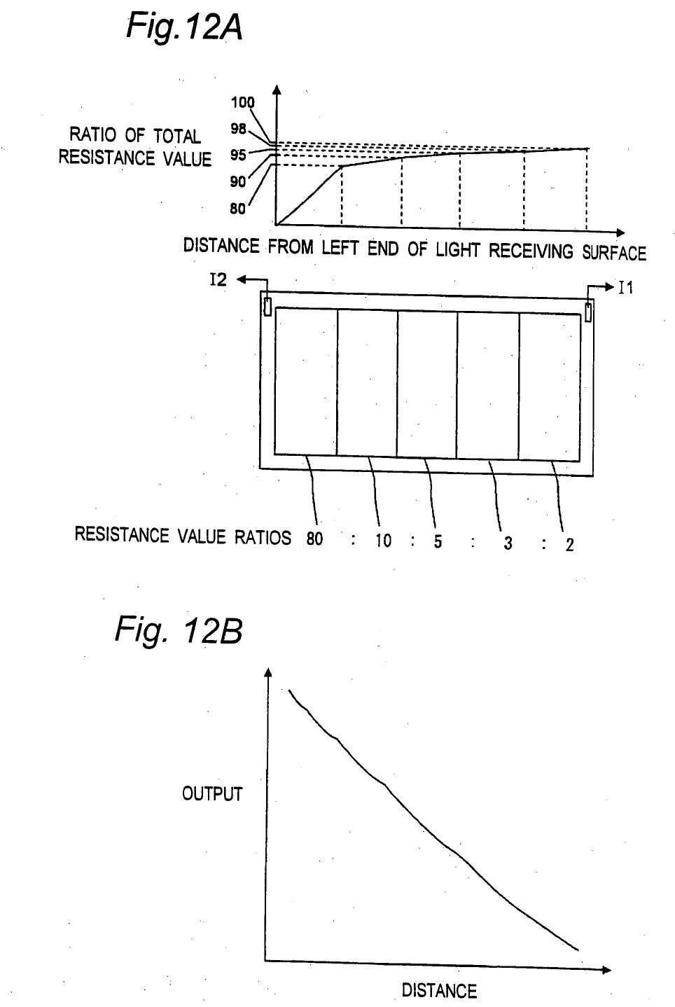

FIG. 12A shows a graph for explaining the ratio of the total resistance at a distance from the left end of the light receiving surface (light emitting device 502) of the position detecting light receiving device 503 (resistance value on the left side corresponding to the distance from the left end/total resistance value from the right end to the left end) . As shown in FIG. 12A, the light receiving regions 503a-503e (ratios of resistance values are 80:10:5:3:2) are arranged in order from the left end of the light receiving surface, and therefore, the ratio of the total resistance value changes gradually from the left end.

FIG. 12B shows the output characteristic of the position detecting light receiving device 503.

The features of the optical ranging sensor including the position detecting light receiving device 503 of the present invention are described next with reference to FIGS. 11A, 11B, 12A and 12B.

As shown in FIG. 11A, light emitted from the light emitting device 502 is condensed by the light projecting condenser portion 508 and projected almost perpendicularly to an object 512 to be ranged. The light is diffuse reflected on the object 512 to be ranged, and only the light incident on the light receiving condenser portion 509 is condensed, forming a light spot on the light receiving surface of the position detecting light receiving device 503. When the distance from the optical ranging sensor to the object to be ranged changes, the position of the light spot on the light receiving surface changes. Therefore, an output value obtained by I1/(I1+I2) is obtained on the assumption that the current values obtained from two terminals of the position detecting light receiving device 503 are I1 and I2. When the light receiving surface is one and the resistance values of the light receiving regions 503a-503e are uniform, the output value is inversely proportional to the distance from the optical ranging sensor to the object to be ranged. However, according to the present invention, the resistance values of the light receiving regions 503a-503e of the light receiving portions that are divided in multiplicity are mutually different, so that the larger resistance value results in the position on which the reflected light is incident on the light emitting device 502 side of the optical ranging sensor, i.e., when the object to be ranged is located remote and the smaller resistance value results in the position on which the reflected light is incident when the object to be ranged is located nearby.

When the object to be ranged moves over a definite distance, the quantity of positional change in the light spot on the light receiving surface is larger when the object is located nearby than when the object is located remote. Therefore, the resistance value of the large quantity of positional change of the light spot is made small, and the resistance value of the small quantity of positional change of the light spot is made large. In detail, the number of divisions of the light receiving portion is set to five, the areas of the light receiving regions 503a-503e are equalized, and the ratios of the resistance values of the five light receiving regions 503a-503e are set at 80:10:5:3:2 in order from the light emitting device 502 side (refer to FIGS. 11B and 12A) so that the output becomes almost proportional of the distance to the object to be ranged.

With this arrangement, an optical ranging sensor capable of accurately obtaining an output proportional to the distance of the object in a wide ranging zone with a simple construction as shown in FIG. 12B and uniforming the ranging accuracy in the entire wide ranging zone can be provided.

Moreover, even if the linearity is improved as described above, the linearity of the output cannot be obtained unless the reflected light from the object to be ranged located at a prescribed distance is condensed to a prescribed position of the position detecting light receiving device 503. In practice, it can be considered that the positional relation between the light receiving condenser portion 509 and the position detecting light receiving device 503 is varied and the linearity of the output is degraded.

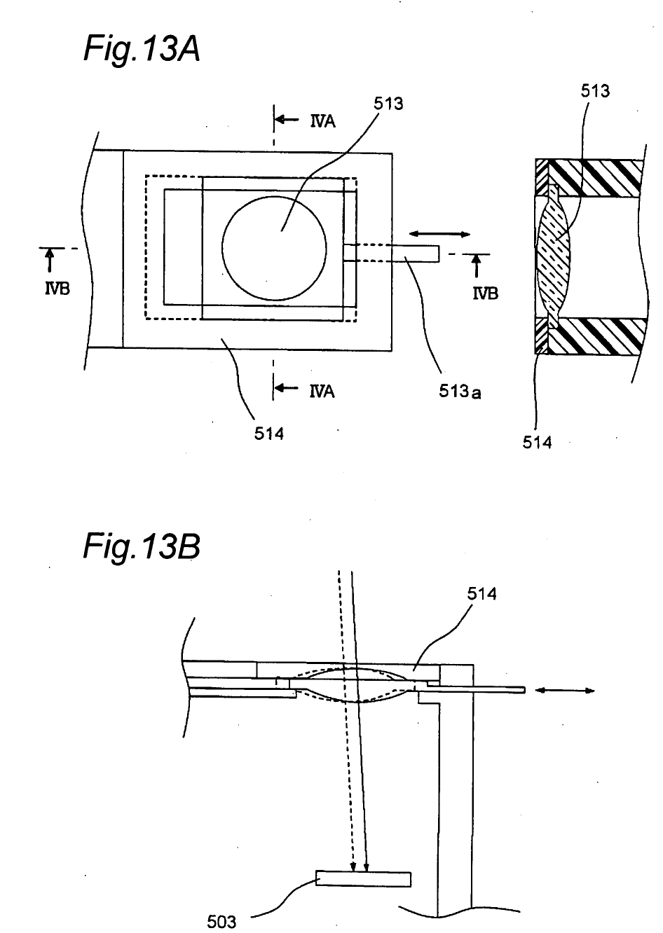

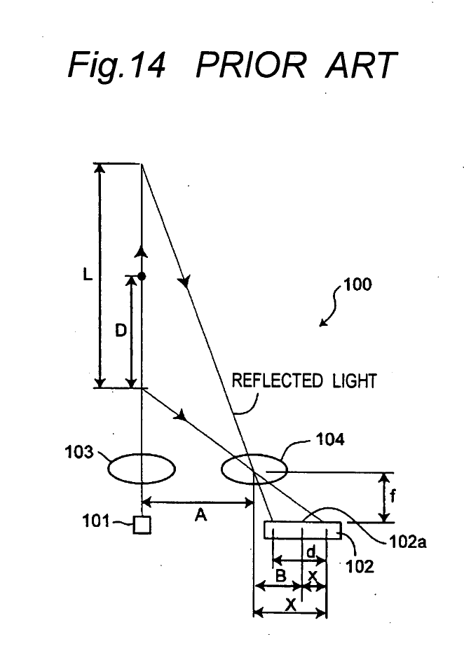

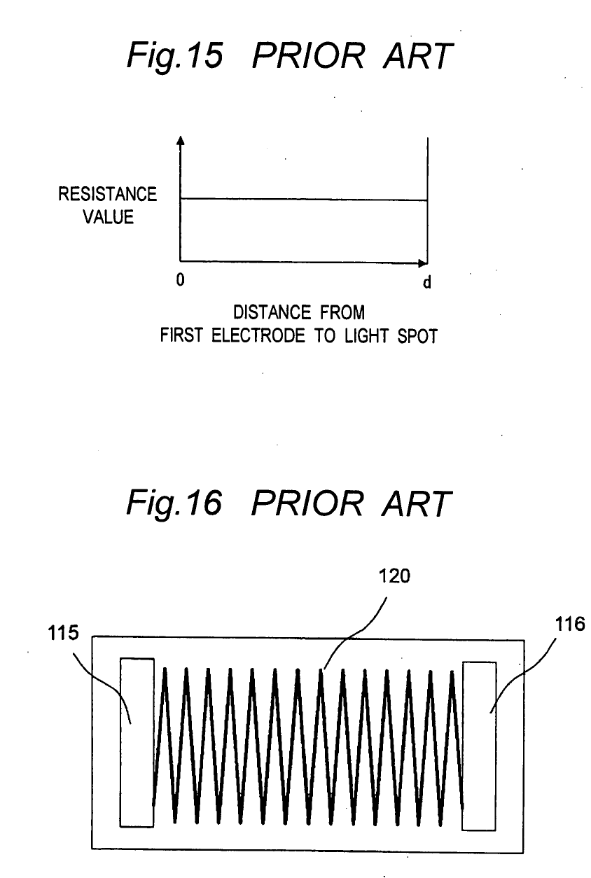

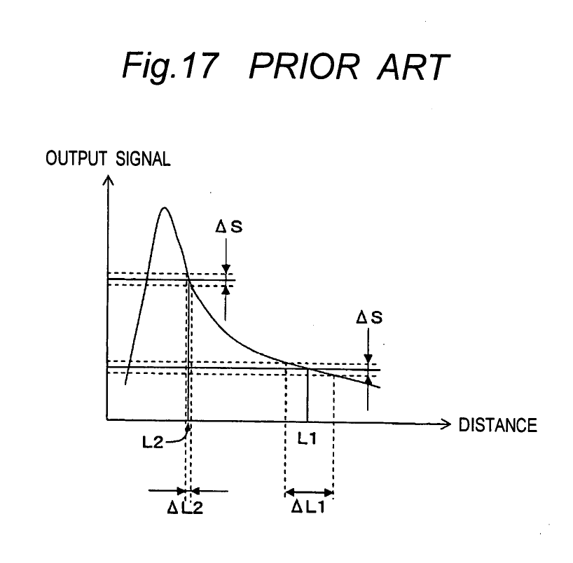

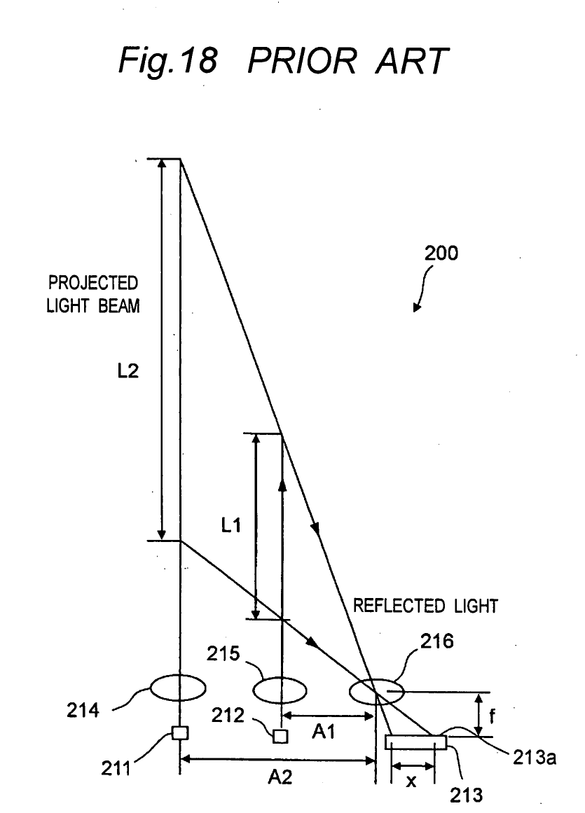

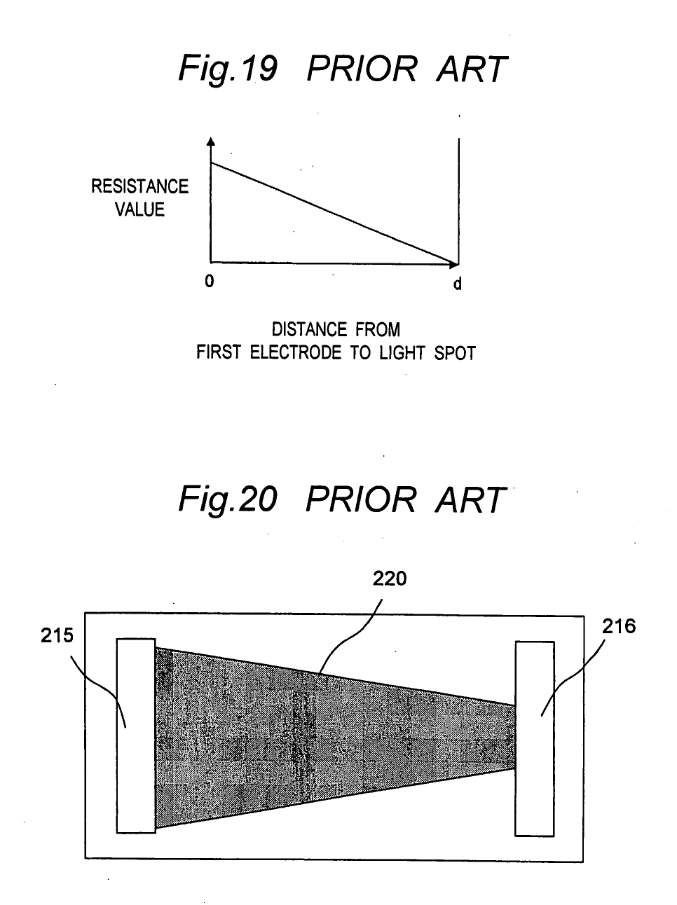

In contrast to the above, by providing a structure capable of moving the light receiving condenser portion 513 as shown in FIGS. 13A and 13B and changing the light condensing position formed on the position detecting light receiving device 503, a light spot can be formed at a prescribed position. With this arrangement, an optical ranging sensor of which the output is almost proportional to the distance of the object can be provided. Even when the distance of the object is comparatively long, the change in the output with respect to the change in the distance can be taken large, and accurate detection can be achieved.

In concrete, a projection 513a for positional adjustment is provided for the light receiving condenser portion 513 and placed so as to move in the illustrated arrow (horizontal) direction, and a cover 514 is provided. With this arrangement, positional adjustment of the light receiving condenser portion 513 is performed, and the reflected light from the object to be ranged located at the prescribed distance is condensed to the prescribed position of the position detecting light receiving device 503. By virtue of the provision of the structure as described above, an optical ranging sensor of which the output is more accurately proportional to the distance to the object can be provided.

The warm water wash toilet seat, on which the conventional optical ranging sensor is mounted, is the system that detects whether or not a person is sitting on the toilet seat and carries out the prescribed functions when the person is sitting there. However, since the position where the person sits on the toilet seat varies depending on the individuals, the distance from the optical ranging sensor to the person is not constant. Since the output also varies in accordance with the distance regarding the, a problem that no person is detected even when a person sits on the toilet seat might occur.

In contrast to the above, if the optical ranging sensor of the present invention is mounted on the warm water wash toilet seat, the variation in the output of the optical ranging sensor with respect to the distance is small. Therefore, the person can reliably be detected, and the functions of the warm water wash toilet seat can be carried out as prescribed.

Although the warm water wash toilet seat that employs the optical ranging sensor has been described in the embodiment, the present invention is not limited to this, and the optical ranging sensor of the present invention may be applied to other equipment.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An optical ranging sensor of an optical trigonometrical ranging system comprising:
a light emitting device for emitting light;
a light projecting condenser means for condensing the light emitted from the light emitting device and projecting the light onto an object to be ranged;
a light receiving condenser means for condensing reflected light from the object to be ranged; and
a light receiving device, which is arranged so that the light receiving surface thereof is perpendicular to an optical axis of the light emitted from the light emitting device and receives the reflected light condensed by the light receiving condenser means, wherein
the light receiving device has two electrodes provided at prescribed intervals on the light receiving surface along a baseline that connects the light emitting device with the light receiving device and a resistive region provided between the two electrodes,
an electric charge generated at an incident position of light on the light receiving surface of the light receiving device becomes a photo current and is outputted from the two electrodes via the resistive region, and
a resistance value of the resistive region of the light receiving device is distributed so as to be roughly inversely proportional to a distance from an optical axis of the light receiving condenser means to an incident position of a light spot on the light receiving surface.

2. The optical ranging sensor as claimed in claim 1, wherein
the resistive region has a zigzag bent line whose line width and return pitch interval are roughly identical, and the resistance value of the resistive region is distributed so as to be roughly inversely proportional to the distance from the optical axis of the light receiving condenser means to the incident position of the light spot on the light receiving surface by changing a stroke length of the bent line configuration from one electrode toward the other electrode of the two electrodes.

3. The optical ranging sensor as claimed in claim 1, wherein
the resistive region has a zigzag bent line whose stroke length and line width are roughly identical, and the resistance value of the resistive region is distributed so as to be roughly inversely proportional to the distance from the optical axis of the light receiving condenser means to the incident position of the light spot on the light receiving surface by changing a return pitch interval of the bent line configuration from one electrode toward the other electrode of the two electrodes.

4. The optical ranging sensor as claimed in claim 1, wherein
the resistive region has a zigzag bent line whose stroke length and return pitch interval are roughly identical, and the resistance value of the resistive region is distributed so as to be roughly inversely proportional to the distance from the optical axis of the light receiving condenser means to the incident position of the light spot on the light receiving surface by changing a line width of the bent line configuration from one electrode toward the other electrode of the two electrodes.

5. The optical ranging sensor as claimed in claim 1, wherein
the resistive region is a semiconductor layer having a zigzag bent line whose line width and return pitch interval are roughly identical, and the resistance value of the resistive region is distributed so as to be roughly inversely proportional to the distance from the optical axis of the light receiving condenser means to the incident position of the light spot on the light receiving surface by changing an impurity concentration of the semiconductor layer of the bent line configuration from one electrode toward the other electrode of the two electrodes.

6. An optical ranging sensor for detecting a distance to an object to be ranged by a trigonometrical ranging system comprising:
a light emitting device;
a light projecting condenser portion for condensing the light emitted from the light emitting device and projecting the light onto an object to be ranged;
a light receiving condenser portion for condensing reflected light from the object to be ranged;
a position detecting light receiving device, which is arranged so that a plane including the light receiving surface thereof is perpendicular to an optical axis of the light emitted from the light emitting device and receives the reflected light condensed by the light receiving condenser portion; and
an integrated circuit for carrying out processing of a signal outputted from the position detecting light receiving device and driving the light emitting device in accordance with a prescribed timing, wherein
the light receiving portion of the position detecting light receiving device is divided into a plurality of light receiving regions arranged along a baseline that connects the light emitting device with the position detecting light receiving device, and
the plurality of divided light receiving regions of the light receiving portion have mutually different resistance values.

7. The optical ranging sensor as claimed in claim 6, wherein
a number of divisions of the light receiving portion of the position detecting light receiving device and the resistance values of the plurality of light receiving regions are set so that the output of the position detecting light receiving device is roughly proportional to the distance of the object to be ranged.

8. The optical ranging sensor as claimed in claim 7, wherein
the number of divisions of the light receiving portion of the position detecting light receiving device is five, areas of the plurality of divided light receiving regions are equalized, and ratios of the resistance values of the plurality of light receiving regions are 80:10:5:3:2 in order from the light emitting device side.

9. The optical ranging sensor as claimed in claim 6, wherein
the light receiving condenser portion is movable along a direction in which a light condensing position on the position detecting light receiving device moves in accordance with the distance to the object to be ranged, and
the light condensing position on the position detecting light receiving device can be changed by moving the light receiving condenser portion.

10. A warm water wash toilet seat comprising the optical ranging sensor claimed in claim 6.
